(19) United States
(12) Patent Application Publication
(10) Pub. No.: US 2003/0205665 A1
(43) Pub. Date: Nov. 6, 2003

(54) Sensor movability relative to base for receiving electromagnetic radiation

(76) Inventor: Gilbert Mark Stewart, Naperville, IL (US)

Correspondence Address: PATTI & BRILL, ONE NORTH LASALLE STREET, 44TH FLOOR, CHICAGO, IL, 60602, US

(21) Appl. No.: 10/138,276

(22) Filed: May 3, 2002

(51) Int. Cl. G06M 7/00

(52) U.S. Cl. 250/221

(57) ABSTRACT

An apparatus in one example comprises one or more sensors supported by a base. A first sensor of the one or more sensors is movable relative to the base for receiving a plurality of samples of electromagnetic radiation.

### TECHNICAL FIELD

The invention in one example relates generally to imaging and more particularly to employment of one or more sensors in imaging.

### BACKGROUND

An image-receiving device in one example comprises a base with a set of sensors fixed thereto. The sensors receive electromagnetic radiation from the environment and convert the electromagnetic radiation into electrical signals. The electromagnetic radiation in one example results from reflection of visible light from a target such as an object or a group of objects. In another example, the electromagnetic radiation results from X-rays passing through one or more target objects. In a further example, the electromagnetic radiation results from infrared light that is generated by an object. For example, the image-receiving device stores the electrical signals for future playback. In another example, the image-receiving device employs the electrical signals for real-time display.

The fixed connection between the sensors and the base of the image-receiving device prevents the sensors from moving relative to the base. The sensitivity of each of the sensors varies across the sensing surface of sensor. As one shortcoming, degradation of the sensitivity of the sensor toward the periphery of the sensing surface causes a decrease in resolution of a resultant image portion. The resolution of the resulting image varies and is limited by the mounting and operation of the sensors. As another shortcoming, the resultant image has inconsistent resolution.

Thus, a need exists for enhanced employment of sensors for receiving electromagnetic radiation. A need also exists for enhanced employment of information from such sensors.

### SUMMARY

The invention in one embodiment encompasses an apparatus. The apparatus includes one or more sensors supported by a base. A first sensor of the one or more sensors is movable relative to the base for receiving a plurality of samples of electromagnetic radiation.

Another embodiment of the invention encompasses a method. First information based on a first subportion of a target is received from a sensor upon location of the sensor at a first position relative to a base connected with the sensor. Second information based on a second subportion of the target is received from the sensor upon location of the sensor at a second position relative to the base. The first information and the second information are combined to obtain a representation of the target.

A further embodiment of the invention encompasses an article. The article includes a computer-readable signal-bearing medium. The article includes means in the medium for receiving first information based on a first subportion of a target from a sensor upon location of the sensor at a first position relative to a base connected with the sensor. The article includes means in the medium for receiving second information based on a second subportion of the target from the sensor upon location of the sensor at a second position relative to the base. The article includes means in the medium for combining the first information and the second information to obtain a representation of the target.

### DESCRIPTION OF THE DRAWINGS

Features of exemplary implementations of the invention will become apparent from the description, the claims, and the accompanying drawings in which:

FIG. 1 is a representation of one exemplary implementation of an imaging component that includes a sensing component and a computing component.

FIG. 2 is a representation of another exemplary implementation of the imaging component of FIG. 1.

FIG. 3 is a representation of exemplary details of a base and one or more sensors connected therewith for movement relative thereto in the sensing component of the imaging component of FIG. 1.

FIG. 4 is a representation of one example of movement of the sensors in one dimension relative to the base of the sensing component of the imaging component of FIG. 3.

FIG. 5 is a representation of another example of movement of the sensors in one dimension relative to the base of the sensing component of the imaging component of FIG. 3.

FIG. 6 is a representation of one example of movement of the sensors in two dimensions relative to the base of the sensing component of the imaging component of FIG. 3.

FIG. 7 is a representation of another example of movement of the sensors in two dimensions relative to the base of the sensing component of the imaging component of FIG. 3.

FIG. 8 is a representation of an exemplary division of an image region into a plurality of cells for employment with a target and the sensing component of the imaging component of FIG. 1.

FIG. 9 is a representation of an exemplary division of a cell of FIG. 8 into a plurality of subportions for employment with a sub-target and the sensing component of the imaging component of FIG. 1.

FIG. 10 is a representation of an exemplary subdivision of the cells of FIG. 8.

### DETAILED DESCRIPTION

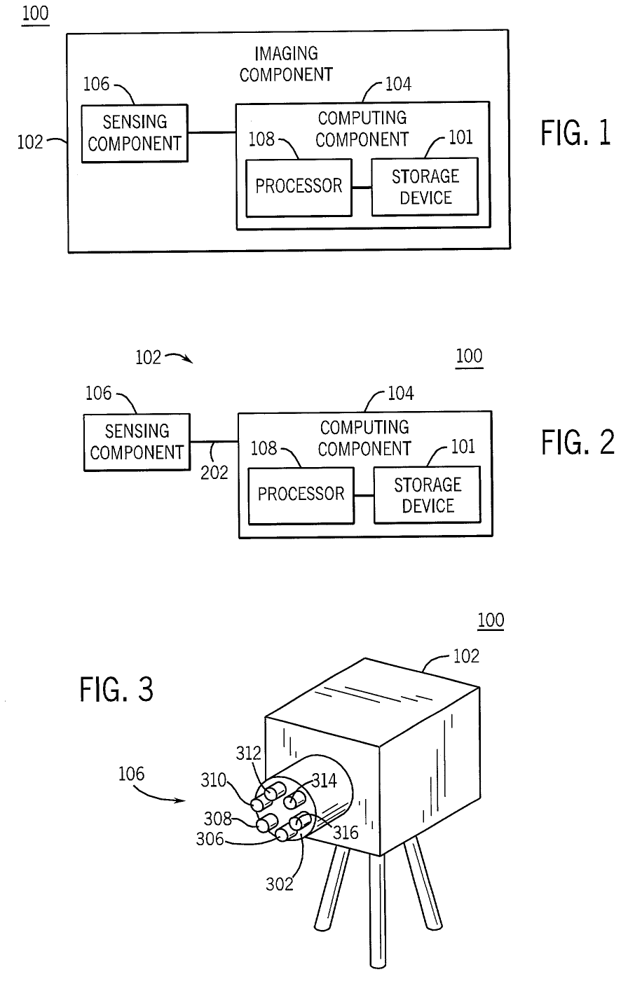

Turning to FIG. 1, an apparatus 100 in one example comprises one or more sensors supported by a base. A first sensor of the one or more sensors is movable relative to the base for receiving a plurality of samples of electromagnetic radiation. A portion of a component of the apparatus 100 in one example comprises all of the component, and in another example comprises a subportion of the component, where the subportion of the component comprises less than all of the component. The apparatus 100 in one example includes a plurality of components such as computer software and/or hardware components. A number of such components can be combined or divided in one example of the apparatus 100.

The apparatus 100 employs at least one computer-readable signal-bearing medium. One example of a computer-readable signal-bearing medium for the apparatus 100 comprises an instance of a recordable data storage medium such as one or more of a magnetic, electrical, optical, biological, and atomic data storage medium. The recordable data storage medium in one example comprises a storage device 101. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

The apparatus 100 comprises an imaging component 102. The imaging component 102 comprises a camera, for example, a digital video camera. The imaging component 102 comprises a computing component 104 and a sensing component 106. In one example, referring to FIG. 1, the computing component 104 and the sensing component 106 comprise subportions of a single component that comprises the imaging component 102. For example, the computing component 104 is housed inside the imaging component 102. In another example, referring to FIG. 2, the computing component 104 and the sensing component 106 comprise distinct components that comprise the imaging component 102. For example, the computing component 104 comprises a personal computer that is coupled with the sensing component 106 through an electronic link 202.

Referring to FIG. 1, the computing component 104 comprises the storage device 101 and a processor 108. The storage device 101 comprises one or more of random access memory (“RAM”), read only memory (“ROM”), one or more hard disks, and one or more floppy disks. The storage device 101 serves to store software instructions. The processor 108 comprises a microprocessor. The processor 108 retrieves the software instructions from the storage device 108 and performs actions in accordance with the software instructions. For example, the software instructions serve to cause the processor 108 to process one or more image samples, as described herein.

Turning to FIG. 3, the imaging component 102 employs the sensing component 106 to receive electromagnetic radiation, as described herein. Referring to FIGS. 3-4 and 6-7, the sensing component 106 comprises a base 302 and one or more sensors, for example, one or more of sensors 306, 308, 310, 312, 314, 316, 402, 404, 406, 408, 602, 612, 614, 616, 618, and 702. The base 302 serves to support the sensor 306 while allowing the sensor 306 to move relative to the base 302 in a plurality of positions for receiving a plurality of samples of electromagnetic radiation.

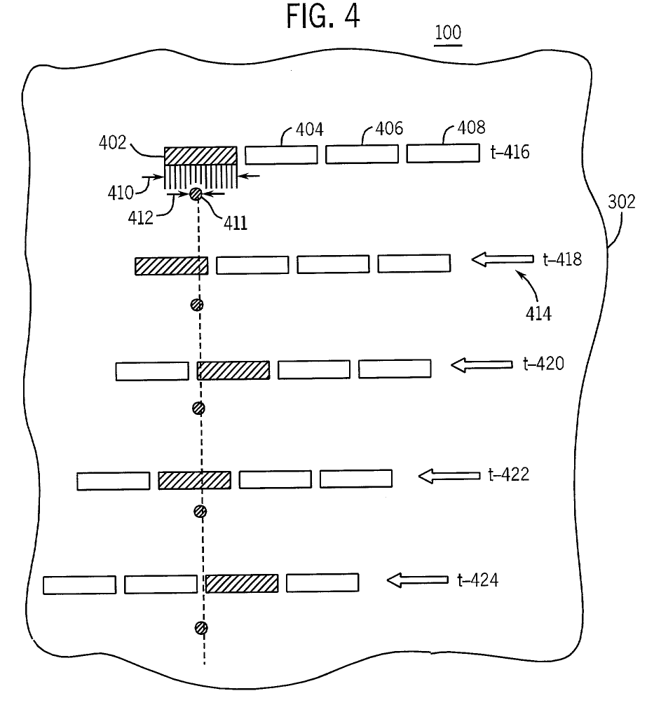

Referring to FIGS. 3-4, the sensor 306 in one example serves to receive information based on a subportion of a target 411. The target 411 in one example comprises a single object. In another example, the target 411 comprises a group of objects or a scene. In one example, the sensor 306 comprises a passive sensor, for example, a photo-resistor. Where the sensor 306 comprises the photo-resistor, the electrical resistance of the sensor 306 varies with the amount of electromagnetic radiation received by the sensor 306. In another example, the sensor 306 comprises an active sensor that serves to output a voltage which varies in relation to the electromagnetic radiation received by the sensor 306. For example, the electromagnetic radiation comprises visible light reflected from the target 411. In another example, the electromagnetic radiation comprises X-rays that pass through the target 411. In a further example, referring to FIGS. 1 and 3-4, the processor 108 employs the sensor 306 to detect a change or discontinuity in the electromagnetic radiation received, for example, to distinguish the target 411 from uniformity, for example, ambient radiation. The sensors 306 serve to receive the electromagnetic radiation, convert the electromagnetic radiation into one or more electrical signals, and transmit the electrical signals to the computing component 104. The processor 108 of the computing component 104 serves to store the electrical signals in the storage device 101 as samples. The sample comprises a piece of information about the target 411. The samples in one example comprise quantized values of the electrical signals.

Turning to FIG. 4, the sensor 402 is capable of sensing the target 411 upon location of the target 411 in a capture region 410 of the sensor 402. The capture region 410 extends outward from an active surface of the sensor 402. The target 411 in one example comprises a size 412 that is smaller than the capture region 410 of the sensor 402. The sensor 402 receives electromagnetic radiation that is reflected from or passes through the target 411 and transmits electrical signals to the processor 108 (FIG. 1) for recording of a sample representative of the target 411.

The sensors 402, 404, 406, and 408 are arranged for movement in one dimension relative to the base 302. The sensors 402, 404, 406, and 408 are capable of linear movement relative to the base 302. The sensors 402, 404, 406, and 408 progressively move relative to the base 302 in a direction 414 at times t-416, t-418, t-420, t-422, and t-424. The direction 414 of movement is exemplary. The direction 414 comprise a single direction, or two directions, for example, where the sensing component 106 repeatedly moves back and forth.

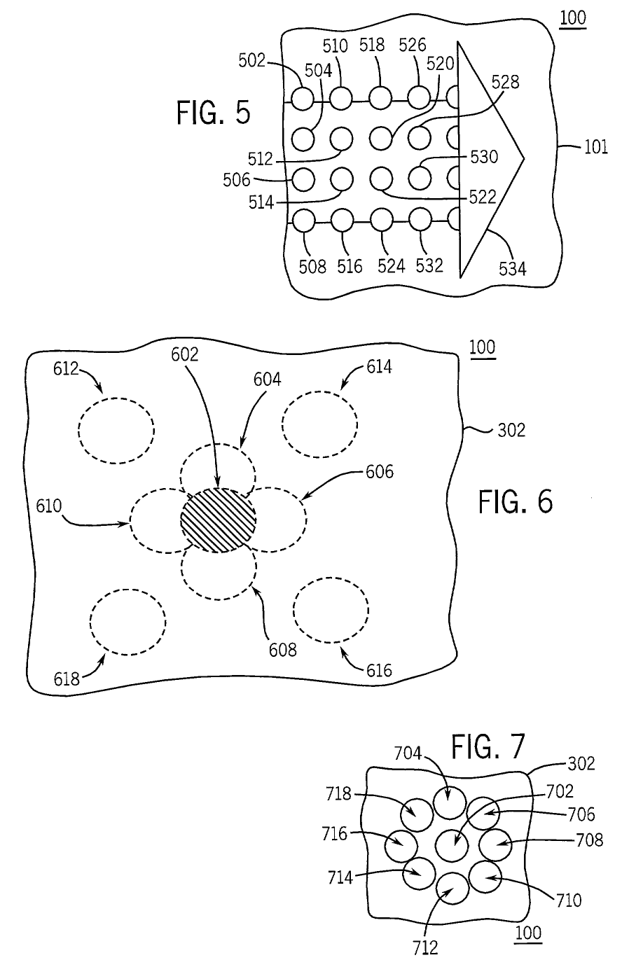

At the time t-416, the sensor 402 receives electromagnetic radiation from the target 411, for example, because the target 411 is located in the capture region 410 of the sensor 402. At the time t-418, the sensor 402 still receives electromagnetic radiation from the target 411. The sensor 402 at the times t-416 and t-418 in one example transmit electrical signals to the processor 108 (FIG. 1) for recording of samples representative of the target 411. The electromagnetic radiation received by the sensor 402 at time t-416 is saved as a sample 502 (FIG. 5). Continuation of the movement of the sensor 402 in the direction 414 causes the sensor 402 to move past the target 411 at the time t-420. Since the target 411 is no longer in the capture region 410 of the sensor 402 at the time t-420, the sensor 402 at the time t-420 no longer receives electromagnetic radiation reflected or transmitted from the target 411.

At the time t-420, the sensor 404 begins receiving electromagnetic radiation reflected by or passing through the target 411, for example, because the target 411 is located in the capture region 410 of the sensor 404. The movement in the direction 414 continues at the time t-422 and the sensor 404 continues receiving electromagnetic radiation reflected or transmitted from the target 411. The sensor 404 at the times t-420 and t-422 transmits electrical signals to the processor 108 for recording of a sample 504 representative of the target 411. Continuation of the movement of the sensor 404 in the direction 414 causes the sensor 404 to move past the target 411 at the time t-424. Since the target 411 is no longer in the capture region 410 of the sensor 404 at the time t-424, the sensor 404 at the time t-424 in one example no longer receives electromagnetic radiation reflected or transmitted from the target 411.

At the time t-424, the sensor 406 in one example begins receiving electromagnetic radiation, for example, because the target 411 is located in the capture region 410 of the sensor 406. The sensor 406 at the time t-424 in one example transmits electrical signals to the processor 108 for recording of a sample 506 representative of the target 411. Continuing movement in the direction 414 causes the sensor 406 to move past the target 411 and move the capture region 410 of the sensor 408 to the target 411 for recording of a sample 508.

Turning to FIG. 5, the storage device 101 serves to store a plurality of samples. The samples 502, 504, 506, and 508 are arranged in a logical progression of an order that the processor 108 records the samples 502, 504, 506, and 508 in the storage device 101. The samples 502, 504, 506, 508, and additional samples are stored in the storage device 101. The samples 502, 504, 506, and 508 together comprise a set representing the region of the target 411 that is to be recorded. The next region of the target 411 to be recorded comprises next set of samples 510, 512, 514, and 516. As more regions of the target 411 are covered, more sets of samples are recorded. A set of samples 518, 520, 522, and 524 represents a sub-target, and a set of samples 526, 528, 530, and 532 represent another sub-target. Direction 534 represents a progressive movement for acquisition of additional sets of samples.

Turning to FIG. 6, the sensors 602, 612, 614, 616, and 618 are arranged for movement in at least two dimensions relative to the base 302. In one example, the sensors 602, 612, 614, 616, and 618 are substantially and/or completely movable in two dimensions relative to the base 302. In another example, the sensors 602, 612, 614, 616, and 618 pivot relative to the base 302.

In one example, the piezoelectric effect serves to vibrate the sensors for movement among the positions. Another example method takes advantage of an inherent motion of a system, such as vibration of a sensor grid mounted on a vehicle, or from simple unavoidable motion of a camera being held by a human. Movement may occur along two or three axes such that the third axis will provide information on relative motion and depth of field. The speed of movement of the sensors affects the resultant output. Increasing the speed of movement and number of samples taken serve to increase the quality or resolution of the resultant image.

The sensor 602 is movable among positions 604, 606, 608, and 610. In one example, the sensor 602 moves progressively through the positions 606, 606, 608, and 610. For example, samples are recorded at predetermined times when the sensor 602 is in known positions. Samples are recorded when the sensor 602 is in the positions 604, 606, 608 and 610. The first sample is taken when the sensor 602 is located at the position 604. The second sample is recorded when the sensor 602 is located at the position 606. The third sample is recorded when the sensor 602 is located at the position 608. The fourth sample is recorded when the sensor 602 is located at the position 610. These samples are grouped together to form sets. A set is a group of related items. In this example a set is the group of four image samples representing the target 411. Larger sets can be formed of these sets, yielding a set comprising sets of image samples. In another example, the sensor 602 moves from position 604 to position 608, and then moves to position 606 and to position 610.

Turning to FIG. 7, the sensor 702 is movable among the positions 704, 706, 708, 710, 712, 714, 716, and 718. In one example, the samples may be taken in a clockwise order, such that the order of progression would be through the positions 704, 706, 708, 710, 712, 714, 716, and 718. In another example, the order would be counterclockwise. In yet another example, the sensor 702 moves from the position 704 to the position 712, from the position 712 to the position 706, from the position 706 to the position 714, from the position 714 to the position 708, from the position 708 to the position 716, from the position 716 to the position 710, and from the position 710 to the position 718, from the position 718 to the position 712, and so on.

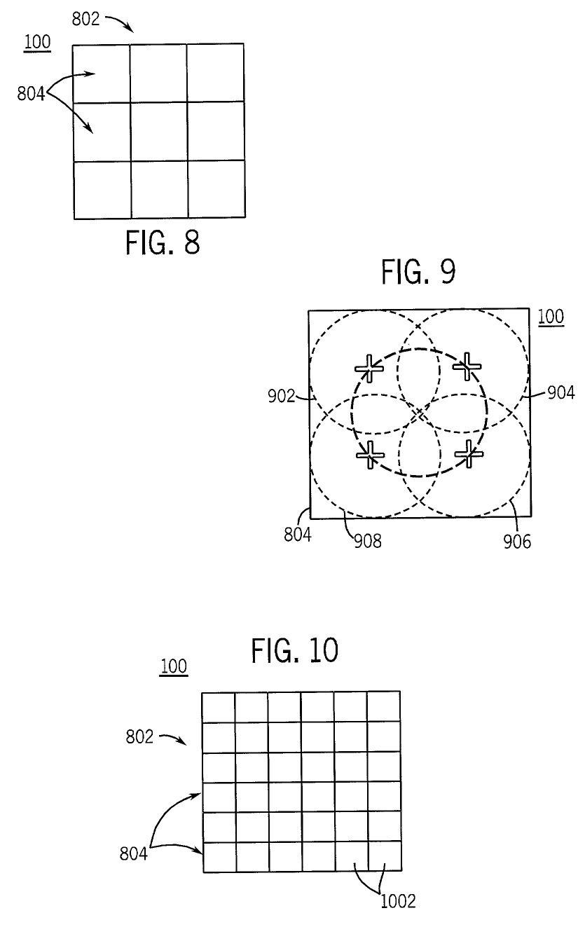

Referring to FIGS. 1, 4, and 8, the sensing component 106 serves to capture image region 802. The image region 802 comprises the capture regions 410 of all the sensors of the sensing component 106. In one example, the image region 802 covers the target 411 and the surrounding environment. For example, a grid that comprises the image region may be overlaid on the target 411 and the immediate surroundings. A plurality of cells 804 of the image region 802 correspond to the sensing component 106. In one example, the image region 802 is divided into nine of the cells 804, each of which corresponds to a respective one of the sensors of the sensing component 106. The density of the sensors on the sensing component 106 directly affects the resultant output from the processor 108. Increasing the number of sensors on the sensing component 106 serves to increase the resultant image quality. One or more regions or sub-targets of the target 411 covered by the one sensor may or may not overlap coverage by one or more neighboring sensors on the sensing component 106. The target 411 may be divided into sub-targets that correspond to the regions of overlapped or non-overlapped coverage by the sensing component 106.

In one example of overlapping coverage, the sensor 306 obtains relatively low-quality information from a portion of a particular sub-target and the sensor 308 obtains relatively high-quality information from the portion of the particular sub-target. The processor 108 obtains a relatively high-quality sample of the portion of the particular sub-target through employment of the relatively low-quality information from the sensor 306 and/or the relatively high-quality information from the sensor 308. The processor 108 in one example employs the information about the portion of the particular sub-target from the sensor 306 and the information about the portion of the particular sub-target from the sensor 308 to an extent determined by the software for the processor 108. For example, algorithms serve to determine the use by the processor 108 of the information from the sensors 306 and 308. In one example, the processor 108 employs only the information from the sensor 308 to obtain the sample for the portion of the particular sub-target. In another example, the processor 108 employs the information from both the sensors 306 and 308 to obtain the sample for the portion of the particular sub-target. The overlapping coverage of the portion of the particular sub-target by the sensors 306 and 308 serves to promote thoroughness and/or improvement in coverage of the portion of the particular sub-target. In addition, the overlapping coverage of the portion of the particular sub-target by the sensors 306 and 308 serves to promote an increase in resolution in a representation of the sub-target output by the processor 108.

In another example of overlapping coverage, referring to FIGS. 1, 4, 6, and 8, the sensor 602 at the position 604 obtains relatively low-quality information from a portion of a particular sub-target and the sensor 602 at the position 606 obtains relatively high-quality information from the portion of the particular sub-target. The processor 108 obtains a relatively high-quality sample of the portion of the particular sub-target through employment of the relatively low-quality information from the sensor 602 at the position 604 and/or the relatively high-quality information from the sensor 602 at the position 606. The processor 108 in one example employs the information about the portion of the particular sub-target from the sensor 602 at the position 604 and the information about the portion of the particular sub-target from the sensor 602 at the position 606 to an extent determined by the software for the processor 108. For example, algorithms serve to determine the use by the processor 108 of the information from the sensor 602 at the positions 604 and 606. In one example, the processor 108 employs only the information from the sensor 602 at the position 606 to obtain the sample for the portion of the particular sub-target. In another example, the processor 108 employs the information from the sensor 602 at both the positions 604 and 606 to obtain the sample for the portion of the particular sub-target. The overlapping coverage of the portion of the particular sub-target by the sensor 602 at the positions 604 and 606 serves to promote thoroughness and/or improvement in coverage of the portion of the particular sub-target. In addition, the overlapping coverage of the portion of the particular sub-target by the sensor 602 at the positions 604 and 606 serves to promote an increase in resolution in a representation of the sub-target output by the processor 108.

In a further example, overlapping coverage by the sensors of the sensing component 106 for selected sub-targets of the target 411 serves to promote thoroughness and/or improvement in coverage of the selected sub-targets of the target 411 and an increase in the resolution in the representation thereof output by the processor 108. In a still further example, overlapping coverage by the sensors of the sensing component 106 throughout the target 411 serves to promote thoroughness and/or improvement in coverage of the target 411 and an increase in the resolution in the representation thereof output by the processor 108.

In one example of non-overlapping coverage, a non-overlapping set of positions for the sensors of the sensing component 106 serves to allow an increase in the number of sub-targets from which the sensors obtain information about the target 411 for the processor 108. The increase in the number of sub-targets in one example serves to promote an increase in resolution in a representation of the target 411 output by the processor 108. In yet another example, non-overlapping coverage by the sensors of the sensing component 106 serves to allow an increase in an overall size or range of the target 411 that the sensing component 106 can cover.

Turning to FIG. 9, a sensor of the sensing component 106 moves among different positions to obtain from coverage areas 902, 904, 906, and 908 of the cell 804 pieces of information about a sub-target in the image region 802. In one example, the coverage areas 902, 904, 906, and 908 overlap at the center of the cell 804. The processor 108 forms an image representative of the sub-target by combining information received from the coverage areas 902, 904, 906, and 908. By combining information received from coverage areas in each of the cells 804, the processor 108 forms an image representative of the target 411. Image samples are received by the processor 108 and stored in the storage device 101. The management and processing of the image samples is handled by the software component. To create a relatively high resolution image, the samples making up each set are superimposed such that a lower-resolution area in one sample from the set is covered by a higher-resolution area in another sample from the set. The overlap serves to minimize the effect of areas of the image that result from information captured using the weaker coverage regions of the sensing component 106. In one example of overlaying the image samples, each sample resembles the product of layering of colored transparencies, each with a subportion of information about an object, to obtain an overall representation of the object from a combination of all the subportions. Another example of processing employs mathematical interpolation techniques.

Turning to FIG. 10, the image region 802 is subdivided into a plurality of sub-cells 1002. For example, each cell 804 in the image region 802 is subdivided into four of the sub-cells 1002. In one cell 804, the four sub-cells 1002 correspond to the coverage areas 902, 904, 906, and 908.

One or more features described herein with respect to one or more of the sensors 306, 308, 310, 312, 314, 316, 402, 404, 406, 408, 602, 612, 614, 616, 618, and 702 in one example apply analogously to one or more other of the sensors 306, 308, 310, 312, 314, 316, 402, 404, 406, 408, 602, 612, 614, 616, 618, and 702.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefor considered to be within the scope of the invention as defined in the following claims.

We claim:

1. An apparatus, comprising:
one or more sensors supported by a base;
wherein a first sensor of the one or more sensors is movable relative to the base for receiving a plurality of samples of electromagnetic radiation.

2. The apparatus of claim 1, wherein the first sensor is movable among a plurality of positions relative to the base for receiving the plurality of samples of electromagnetic radiation.

3. The apparatus of claim 2, wherein the plurality of samples of electromagnetic radiation comprises one or more sets of samples of electromagnetic radiation, wherein the one or more sets of samples of electromagnetic radiation comprises a first set of samples of electromagnetic radiation, wherein the first set of samples of electromagnetic radiation comprises two or more samples of electromagnetic radiation, wherein the plurality of positions relative to the base comprises one or more sets of positions relative to the base, wherein the one or more sets of positions relative to the base comprises a first set of positions relative to the base, wherein the first sensor is movable among the first set of positions relative to the base to receive the first set of samples of electromagnetic radiation.

4. The apparatus of claim 3, wherein the one or more sets of samples of electromagnetic radiation comprises a second set of samples of electromagnetic radiation, wherein the second set of samples of electromagnetic radiation comprises two or more samples of electromagnetic radiation, wherein the first sensor is movable among the first set of positions relative to the base to receive the second set of samples of electromagnetic radiation.

5. The apparatus of claim 3, wherein the one or more sets of samples of electromagnetic radiation comprises a second set of samples of electromagnetic radiation, wherein the second set of samples of electromagnetic radiation comprises two or more samples of electromagnetic radiation, wherein the one or more sets of positions relative to the base comprises a second set of positions relative to the base, wherein the first sensor is movable among the second set of positions relative to the base to receive the second set of samples of electromagnetic radiation.

6. The apparatus of claim 2, wherein the plurality of samples of electromagnetic radiation is based on a target, wherein the plurality of samples of electromagnetic radiation comprises one or more sets of samples of electromagnetic radiation, wherein the one or more sets of samples of electromagnetic radiation comprises a first set of samples of electromagnetic radiation, wherein the first set of samples of electromagnetic radiation comprises a first sample of electromagnetic radiation and a second sample of electromagnetic radiation, wherein the plurality of positions relative to the base comprises a first position relative to the base and a second position relative to the base;
wherein the first sensor is movable to the first position relative to the base to receive the first sample of electromagnetic radiation, wherein the first sample of electromagnetic radiation is based on a first portion of the target;
wherein the first sensor is movable to the second position relative to the base to receive the second sample of electromagnetic radiation, wherein the second sample of electromagnetic radiation is based on a second portion of the target.

7. The apparatus of claim 6, wherein the first and second portions of the target comprise overlapping portions of the target;
wherein the first sensor is movable to the first and second positions relative to the base to receive the respective first and second samples of electromagnetic radiation that serve to provide information about the overlapping portions of the target.

8. The apparatus of claim 6, wherein the first and second portions of the target comprise non-overlapping portions of the target;
wherein the first sensor is movable to the first and second positions relative to the base to receive the respective first and second samples of electromagnetic radiation that serve to provide information about the non-overlapping portions of the target.

9. The apparatus of claim 1, wherein the plurality of samples of electromagnetic radiation comprise a first plurality of samples of electromagnetic radiation, wherein the one or more sensors comprise a second sensor, wherein the second sensor is movable relative to the base for receiving a second plurality of samples of electromagnetic radiation.

10. The apparatus of claim 1, wherein the first sensor is movable among a plurality of positions, in at least one dimension, relative to the base for receiving the plurality of samples of electromagnetic radiation.

11. The apparatus of claim 1, wherein the first sensor is movable among a plurality of positions, in at least two dimensions, relative to the base for receiving the plurality of samples of electromagnetic radiation.

12. A method, comprising the steps of:
receiving first information based on a first subportion of a target from a sensor upon location of the sensor at a first position relative to a base connected with the sensor;
receiving second information based on a second subportion of the target from the sensor upon location of the sensor at a second position relative to the base; and
combining the first information and the second information to obtain a representation of the target.

13. The method of claim 12, wherein the step of receiving the first information based on the first subportion of the target from the sensor upon location of the sensor at the first position relative to the base and the step of receiving the second information based on the second subportion of the target from the sensor upon location of the sensor at the second position relative to the base comprise the step of:
selecting one or more of the first position and the second position to cause the first subportion of the target and the second subportion of the target to comprise overlapping subportions of the target.

14. The method of claim 12, wherein the step of receiving the first information based on the first subportion of the target from the sensor upon location of the sensor at the first position relative to the base and the step of receiving the second information based on the second subportion of the target from the sensor upon location of the sensor at the second position relative to the base comprise the step of:
selecting one or more of the first position and the second position to cause the first subportion of the target and the second subportion of the target to comprise overlapping subportions of the target.

15. The method of claim 12, wherein the step of combining the first information and the second information to obtain the representation of the target comprises the step of:
increasing an accuracy of a part of the second information, through employment of a part of the first information, to obtain the representation of the target.

16. The method of claim 12, wherein the target comprises a first sub-target, wherein the sensor comprises a first sensor, and further comprising the steps of:
receiving third information based on a first subportion of a second sub-target from a second sensor upon location of the second sensor at a third position relative to the base, wherein the second sensor is connected with the base;
receiving fourth information based on a second subportion of the second sub-target from the second sensor upon location of the second sensor at a second position relative to the base; and
combining the third information and the fourth information to obtain a representation of the second sub-target.

17. The method of claim 16, wherein an overall target comprises a plurality of sub-targets that comprises the first sub-target and the second sub-target, wherein the step of combining the first information and the second information to obtain the representation of the first sub-target and the step of combining the third information and the fourth information to obtain the representation of the second sub-target comprise the step of:
combining the first, second, third, and fourth information to obtain a representation of the overall target.

18. An article, comprising:
a computer-readable signal-bearing medium; and
means in the medium for receiving first information based on a first subportion of a target from a sensor upon location of the sensor at a first position relative to a base connected with the sensor;
means in the medium for receiving second information based on a second subportion of the target from the sensor upon location of the sensor at a second position relative to the base; and
means in the medium for combining the first information and the second information to obtain a representation of the target.

19. The article of claim 18, wherein the means in the medium for combining the first information and the second information to obtain the representation of the target comprises:
means in the medium for increasing an accuracy of a part of the second information, through employment of a part of the first information, to obtain the representation of the target.

20. The article of claim 18, wherein the target comprises a first sub-target, wherein the sensor comprises a first sensor, and further comprising:
means in the medium for receiving third information based on a first subportion of a second sub-target from a second sensor upon location of the second sensor at a third position relative to the base, wherein the second sensor is connected with the base;
means in the medium for receiving fourth information based on a second subportion of the second sub-target from the second sensor upon location of the second sensor at a second position relative to the base;
means in the medium for combining the third information and the fourth information to obtain a representation of the second sub-target;
wherein an overall target comprises a plurality of sub-targets that comprises the first sub-target and the second sub-target, wherein the means in the medium for combining the first information and the second information to obtain the representation of the first sub-target and the means in the medium for combining the third information and the fourth information to obtain the representation of the second sub-target comprise:
means in the medium for combining the first, second, third, and fourth information to obtain a representation of the overall target.
